(19) United States
(12) Patent Application Publication
(10) Pub. No.: US 2014/0082021 A1
(43) Pub. Date: Mar. 20, 2014

(54) HIERARCHICAL ORDERING OF STRINGS

(71) Applicant: Geoffrey R. Hendrey, San Francisco, CA (US)

(72) Inventor: Geoffrey R. Hendrey, San Francisco, CA (US)

(21) Appl. No.: 14/030,863

(22) Filed: Sep. 18, 2013

Related U.S. Application Data
(60) Provisional application No. 61/702,578, filed on Sep. 18, 2012.

(51) Int. Cl. G06F 17/30

(52) U.S. Cl. CPC G06F 17/30495
USPC 707/772

(57) ABSTRACT

A computer-implemented method of comparing strings is presented. The method entails mapping a first string and a second string in a multi-dimensional space where each axis represents a character in the first and/or second strings. The mapped positions of the first and second strings in the multi-dimensional space are used to generate first and second one-dimensional representations of the first and second strings, respectively. The degree of similarity between the first string and the second string is determined based on a difference between the first and second one-dimensional representations. The mapping of the strings in a multi-dimensional space may entail dividing an axis into a first region and a second region, assigning the string to the first or second region depending on the presence or absence of a character, and further subdividing the regions to represent different positions of the character in the string.

### CROSS-REFERENCE TO RELATED APPLICATION(S)

This application claims the benefit of U.S. Provisional Application No. 61/702,578 filed on Sep. 18, 2012, the content of which is incorporated by reference herein.

### FIELD OF INVENTION

This disclosure relates to ordering strings in a multi-dimensional space and comparing the strings.

### BACKGROUND

Today, data is collected about many different types of activities more frequently than ever before. The advancement of such data collection capability has been accompanied by an evolution in data storage capability, as the enormous amount of data that is collected has to be stored and made accessible. While a lot of data is now available due to the advancement in data collection capability and data storage methods, it is not always easy to translate the enormous amount of available data into useful information.

Approximate string matching remains an active area of research due to the need to find computational techniques that scale beyond small dictionaries and provide fast approximate matching on very large datasets. Examples of current state of the art methods include the deletion-neighborhood approach, and table-driven finite state automata. However, there is much room for new and improved ways to process queries against a large corpus of data, often in the Terabyte range.

### SUMMARY

In one aspect, the inventive concept pertains to a computer-implemented method of comparing strings. The method entails mapping a first string and a second string in a multi-dimensional space where each axis represents a character in the first and/or second strings. The mapped positions of the first and second strings in the multi-dimensional space are used to generate first and second one-dimensional representations of the first and second strings, respectively. The degree of similarity between the first string and the second string is determined based on a difference between the first and second one-dimensional representations.

In another aspect, the inventive concept pertains to mapping a string in a multi-dimensional space that includes a first axis that represents a first character. The method includes dividing the first axis into a first region and a second region, assigning the string to the first region if a first character is absent from the string, and assigning the string to the second region if the string includes the first character. The second region may be further subdivided into a third region and a fourth region and the string assigned to one of the third and fourth regions based on position of the first character in the string. Each sub-region may continue to be further divided, such that the number of divisions equals the number of digits in the string.

An additional axis may be added to the space to represent each character in the string. A string will have a location in the space that is defined by the type, frequency, and position of the characters in the string. The location may be converted to a one-dimensional representation, such as an integer.

The one-dimensional number generated in the above manner may be used to process queries. For example, a query string may be matched with one or more strings in a corpus of data by comparing the one-dimensional representation of the query string with one-dimensional representations of strings in the corpus.

In another aspect, the inventive concept pertains to a non-transitory computer-readable medium storing instructions that, when executed, cause a computer to perform a method for placing a string on a one-dimensional space filling curve by mapping the string in a multi-dimensional space, logically assigning positions for each character in the string in the multi-dimensional space, and converting the positions into a one-dimensional representation.

### BRIEF DESCRIPTION OF THE DRAWINGS

FIG. 1A is a flowchart depicting the general process of the disclosure for converting a string into an integer.

FIG. 1B illustrates the general process of comparing strings using the distances between their one-dimensional representations.

FIG. 2 illustrates a hierarchical axis division schema by showing a top-level division of the A-axis.

FIG. 3 illustrates a reformulation of the concept illustrated in FIG. 2 by using a notation A₀ and ˜A₀.

FIG. 4 illustrates a second-level division of the space.

FIG. 5 illustrates a third-level division of the space.

FIG. 6 illustrates the multi-level division as applied to a two-dimensional “space” including two axes.

FIG. 7 illustrates a second-level division performed in one of the quadrants/regions of the two-dimensional “space” of FIG. 6.

FIG. 8 is a flowchart depicting the mapping process described in reference to FIGS. 2-7.

FIG. 9 illustrates binary representations for the string ABABB.

FIG. 10 is a flowchart depicting an index-matching process 30.

FIG. 11 is a flowchart depicting a simplified character-index-based mapping process.

FIG. 12 depicts a flowchart illustrating a Modified Interleaving method.

### DETAILED DESCRIPTION

A method and system for comparing strings (e.g., to process a query) is provided. More specifically, a method and system for matching a set of strings that most closely match a query string is presented. In one aspect, the inventive concept provides a fast, approximate string matching that is useful for discrete words and scales up to be used with a group of words (e.g., sentences).

In one aspect, the disclosure includes a method of ordering strings in a multi-dimensional space such that similar strings end up within a predefined Levenshtein distance of one another.

In another aspect, the inventive concept includes a method of performing approximate string matching in which an input string is used to retrieve output strings that have low Levenshtein distances to the input string. This method may be useful for spell checking, among other functions.

In another aspect, the inventive concept includes a method of organizing an inverted index so that the posting lists′ keys are compatible with the approximate string matching method.

A “string,” as used herein, is one or more characters. For example, a string may be a word (“doggy”) or a sentence (“where is the doggy?”). Characters include letters, numbers, and symbols.

Data is usually stored in the form of strings. When a query is received, usually in the form of strings, it is desirable to be able to find the best-matching data efficiently, without heavily taxing the memory or the computational capability of the computing system. The method disclosed herein avoids having to store a huge amount of data in memory, and also avoids having to execute a large amount of computation per query. In one aspect, the inventive concept converts the query to a vector and maps it on a space-filling curve to generate a one-dimensional index. As the one-dimensional index can be traversed with a single-range scan, finding a match to the query string is efficient both in terms of cost and speed. The method converts the words in a corpus to a list of simple ordered integers, which may be stored in well-known disc-based structures such as a B-tree without the need for a RAM-resident main structure.

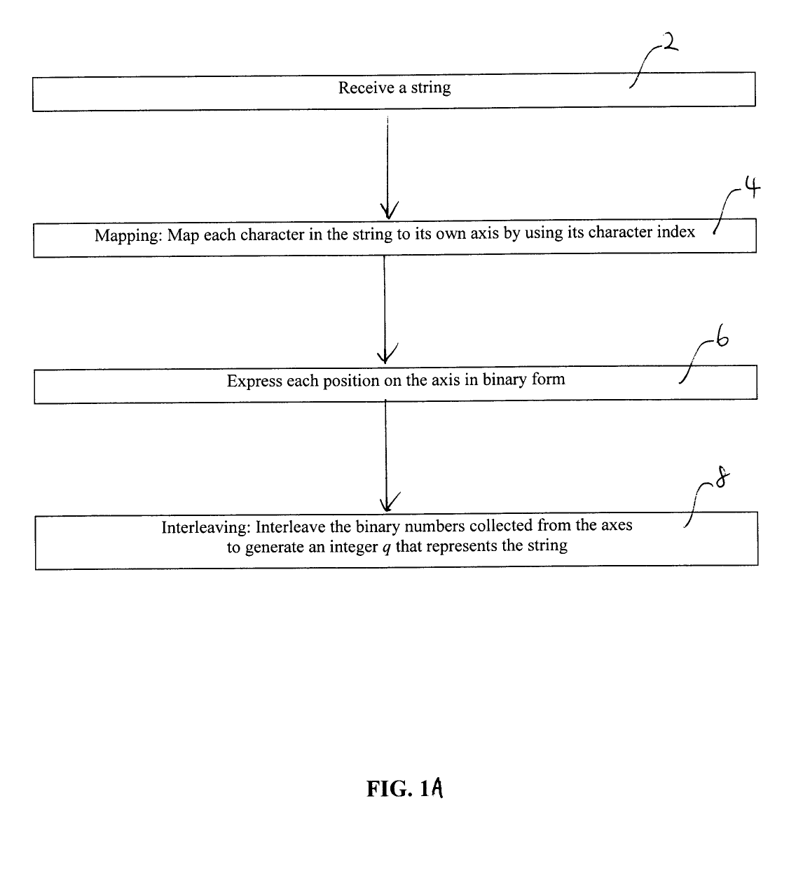

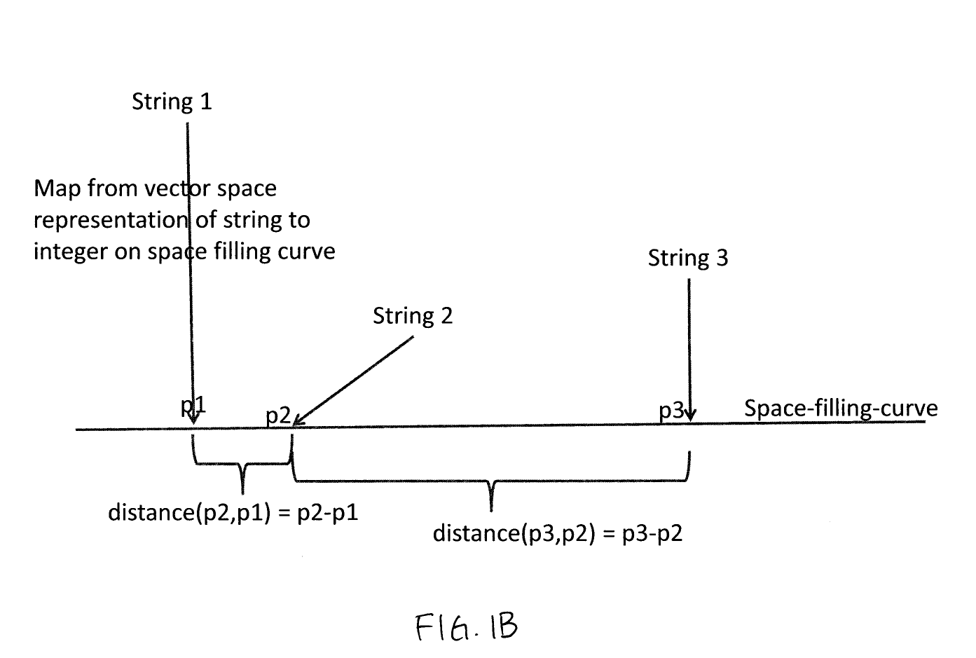

FIG. 1A is a flowchart depicting the general process of the disclosure for converting a string into an integer. As shown, a string is received (step 2). A string includes one or more characters, and each character has its own axis in a space. By using the character index of each character in the string, which takes into account the position of the character in the string as well as its frequency of appearance in the string, mapping is performed for each character onto the corresponding axis (step 4). This Mapping process is described in more detail below. A character that does not appear in the string gets assigned a value of zero. Each position on the axis is then converted to a binary number (step 6), and the binary numbers are interleaved to generate a new binary number that corresponds to an integer q (step 8), and this Interleaving process will be explained in detail below. The process takes advantage of the fact that a Hilbert curve changes the axis values in a gray-code order, in small increments. Incorporating the mapping process onto a Hilbert curve eliminates changes that occur to multiple axes simultaneously such would be the case in natural incrementing of a binary integer when more than one bit simultaneously changes value (for instance in the incrementing of 0111 to 1000 in which the decimal 7 is incremented to 8 and 4 bits simultaneously change value).

A point in a k-dimensional space is sometimes represented as an integer in which successive bits of the integer divide the axes of the space. There are techniques for converting between a point on a space-filling curve such as a Hilbert curve and the integer-point representation in a k-dimensional space. The Hilbert curve represents a re-ordering of the integer representation of points in k-dimensional space such that points near each other by metrics such as Euclidean distance tend to be near each other in a one-dimensional natural ordering of the Hilbert numbers. This disclosure includes a method of creating an integer representation of a string in a k-dimensional space so that known methods of Hilbert encoding may be applied. In so doing, an ordering will be created such that strings near each other in the one-dimensional ordering will be similar to each other by a Levenshtein distance metric. This facilitates fast approximate string matching.

FIG. 1B illustrates how, after the strings are converted into one-dimensional representations such as integers, they can be compared in a fast, efficient way. The particular example in FIG. 1B shows three strings: String 1, String 2, and String 3. In a simple case, String 1 may be a query string and Strings 2 and 3 may be strings in the corpus. Using the process outlined in FIG. 1A, each of these strings is converted to an integer so that they become integer p1, integer p2, and integer p3. As shown, the integers p1, p2, and p3 are laid out on a one-dimensional space-filling curve according to their relative magnitudes: p1<p2<p3.

To determine how similar the strings are to one another, the differences between them are calculated, for example in the form of distances. Hence, of the three strings shown in the example, String 1 and String 2 represented by integers p1 and p2 are the most similar (because distance p2-p1 is the shortest), String 2 and String 3 are not too similar (as the distance p3-p2 is not short, qualitatively speaking), and String 1 and String 3 are very different (as indicated by the long distance p3-p1).

### Mapping

To map an integer representation of a string onto a space-filling curve, a hierarchical division of a logical “space” is performed such that strings are mapped in that space. In the method to be disclosed, an integer represents the hierarchical division of the string space as a series of logic tests. Various techniques—such as known techniques for converting an integer representation of a point in k-dimensional space to a point on the Hilbert curve—may be used to convert an integer representation of a point in a k-dimensional space to a point on the Hilbert curve.

Strings may be represented as points in k-dimensions in the following manner:
Given an alphabet of k characters, let there be k axes, one axis for each member (e.g., for 26 letters (A through Z), there will be 26 axes)
Let the numeric integer range of each axis span[0, MAX]

Given a string such as “CAT” or “DOG,” the objective is to represent this string as a single point in 26 dimensions (i.e., a value in the range [0, MAX] on each of the 26 axes). Since each axis encodes some information about a particular character in the alphabet, some simple strings can be examined, such as strings built using just one character of the alphabet, e.g., “A,” “AA,” and “AAA.” The integer value of the string “A” on the A-axis should be closer to the value of “AA” than it is to “AAA” if there is to be a relationship between Euclidean distance and Levenshtein distance. Simply using the number of occurrences of A—the cardinality of A—as the value might make sense for strings consisting only of a single character of the alphabet; however, it can break down when more than one member of the alphabet is introduced. For example, this simple number-of-occurrence method would make the values on the A-axis for “A,” “AA,” and “AAA” 1, 2, and 3, respectively. However, this simple method would represent strings “ABAB” and “AABB” by the value 2 on the A-axis and the value 2 on the B-axis, thus placing them both at {2,2,0,0,0, . . . , 0} in 26 dimensions and failing to differentiate them. Therefore, a simple system using primarily the cardinality of a particular character in a string would give two dissimilar strings a Euclidean distance of zero from each other (and a Levenshtein distance of 2 (one deletion, one insertion)), which is insufficient for accurate integer conversion.

A hierarchical, logic-based mapping of the string to Euclidean space that facilitates a mapping to the Hilbert curve is presented in this disclosure. In the method that is disclosed, the spatial organization of strings places similar strings near each other with regard to Euclidean distance. With the hierarchical approach, nested regions of increasing similarity can be created as the division of the space proceeds from coarse to fine.

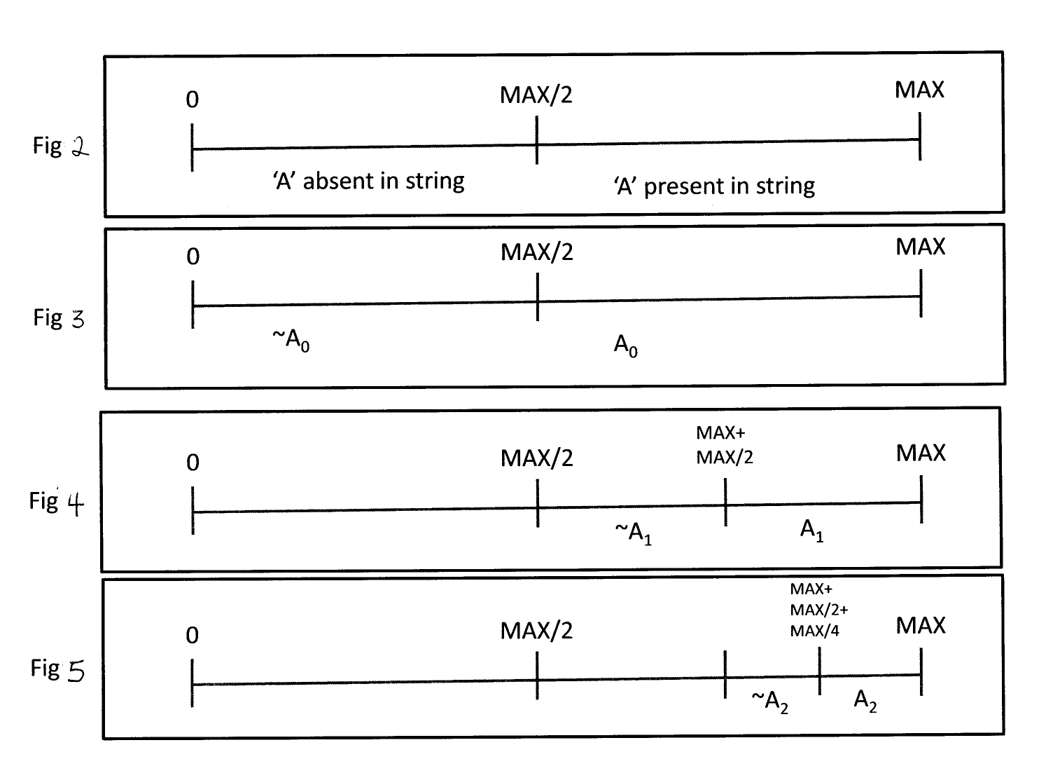

FIG. 2 illustrates the schema by showing a top-level (with regard to hierarchy) division of the A-axis. The midway point, MAX/2, is used to represent a boundary between strings that possess the letter “A” and strings that do not possess the letter “A” (a Boolean logic test). For example, according to this division of the axis, the word CAT would have a value on the A-axis greater than or equal to MAX/2 and less than MAX, or somewhere in the range [MAX/2, MAX]. Initially, the specific value of the location that the word CAT would generate on the A-axis is undetermined—all that is determined is that the location is somewhere in the range [MAX/2, MAX]. The string BLAST would also fall somewhere in the same range on the A-axis (due to the presence of an “A”), where the string DOG would fall somewhere in the range [0, MAX/2] (reflecting the absence of “A”).

By using the value MAX/2 as the dividing point, and by making the top-level division a binary division based on the presence and absence of a character, a hierarchical integer representation of strings is created. As such, the use of single bits to represent the divisions of each axis is logical. The most significant bit (MSB) of the encoding would divide the axis into two halves: if the MSB were zero, then the point would fall in the range [0, MAX/2], whereas if the MSB were 1, then the point would fall in the range [MAX/2, MAX]. Given this encoding, it is convenient to let the absence of a particular character in a string be encoded as a value of zero on the given axis. For example, for the string DOG, all 26 axes will have a zero value except the D-axis, the O-axis, and the G-axis.

It should be noted that although the examples are provided in terms of a single axis (the A-axis), this is done for clarity of explanation and the method can be expanded to multiple-axes situations where the same logic applies to each of the multiple axes.

Each string has a “character index,” which is the right justified ordinal position of a character in the string. Reformulating the top-level division discussed above (“does the string possess the letter A?”) in terms of the character index, the question now becomes “does the string possess the letter A at character index greater than or equal to zero?” Since any string having the letter A would have a character index for A greater than or equal to zero, the two questions are substantially equivalent. The division of the axis in terms of character indices is now reformulated.

FIG. 3 illustrates the reformulation using a notation A₀ to represent the state where “the string possesses the letter A at character index zero or greater” and ˜A₀ to represent the state where “the string does not possess the letter A at character index zero or greater.”

FIG. 4 illustrates a second-level division of the space. To maintain the hierarchical nature of the space, the range [0 to MAX/2] or [MAX/2 to MAX] is further subdivided. Regardless of how the space is subdivided, for all points greater than or equal to MAX/2, the string possesses the letter A because this is the requirement carved out by the top-level division. The question to be asked at the second-level division is, “Does the string possess the letter A at character index 1 or greater?” Depending on the answer to this second-level question, either a notation ˜A₁ or the notation A₁ is assigned to indicate where in the second-level subdivision the values resides.

FIG. 5 illustrates a third-level division of the space. The third-level division is applied to the spaces that are determined by the second-level division. The question to be asked at the third-level division is, “Does the string possess the letter A at character index 2 or greater?” Depending on the answer to this third-level question, either a notation ˜A2 or A2 is assigned to indicate where in the third-level subdivision the value resides.

Given an encoding of the value on an axis as a sequence of bits, it becomes apparent that the method disclosed herein uses as many bits as characters in the strings it is desired to encode, and can produce sequences of zero or more 1-bits followed by zero bits. As a standard integer is 32 bits, 32 characters are sufficient to capture common words in English. For words longer than 32 characters, the method works because questions such as “Does this string possess the letter A at character index 31 or greater?” are still applicable. Therefore, the method still works with strings longer than 32 characters.

Encoding of a value that falls on a single axis is now examined. For example, for the string “AAA,” its encoding as a 32-bit integer value would be 111000 . . . where the total number of zeros is 29 (there are three 1-bits, since A occupies the first and only three characters of the string and there are 29 zeros which are essentially fillers to make 32 bits). The first zero indicates that “the string does not have an A at character-index 3 or greater,” the second zero indicates that “the string does not have the letter A at character-index 4 or greater,” etc. Given a 32-bit representation, MAX would equal to 2³²−1. Therefore, the base-10 numeric value of “AAA” on the A-axis is 2³¹+b 2³⁰+2²⁹.

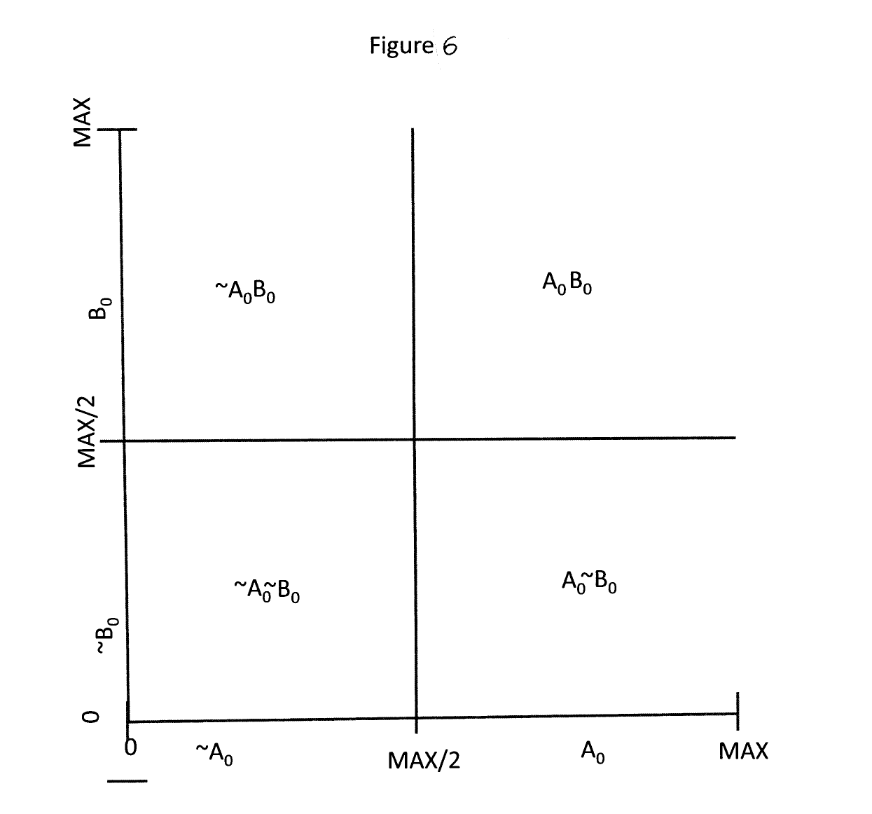

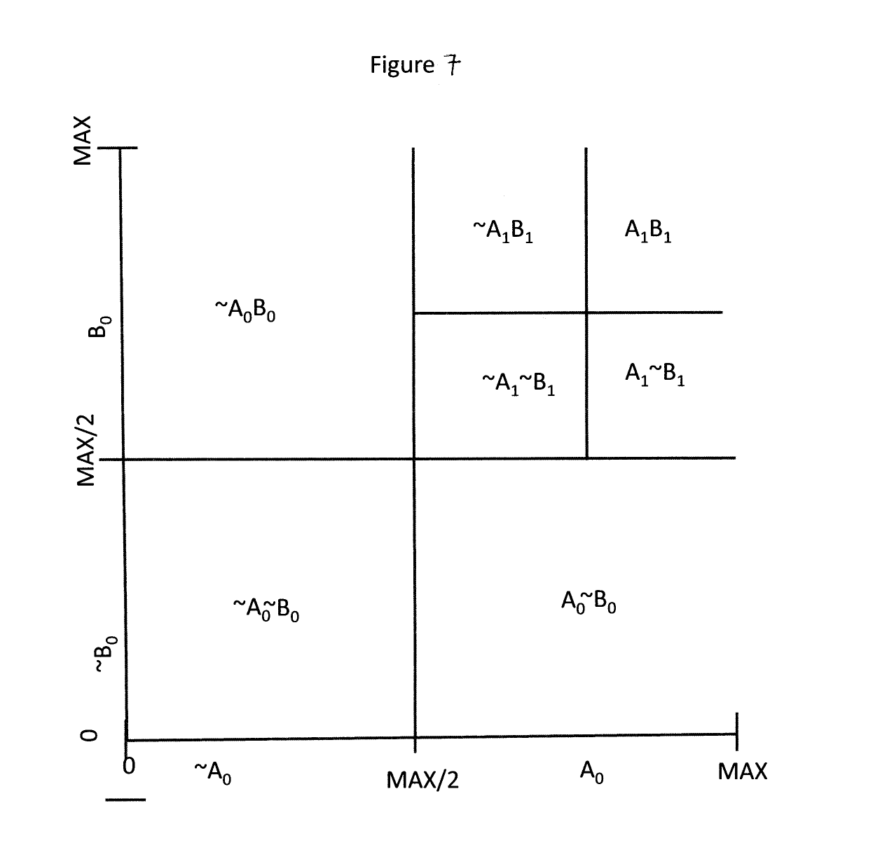

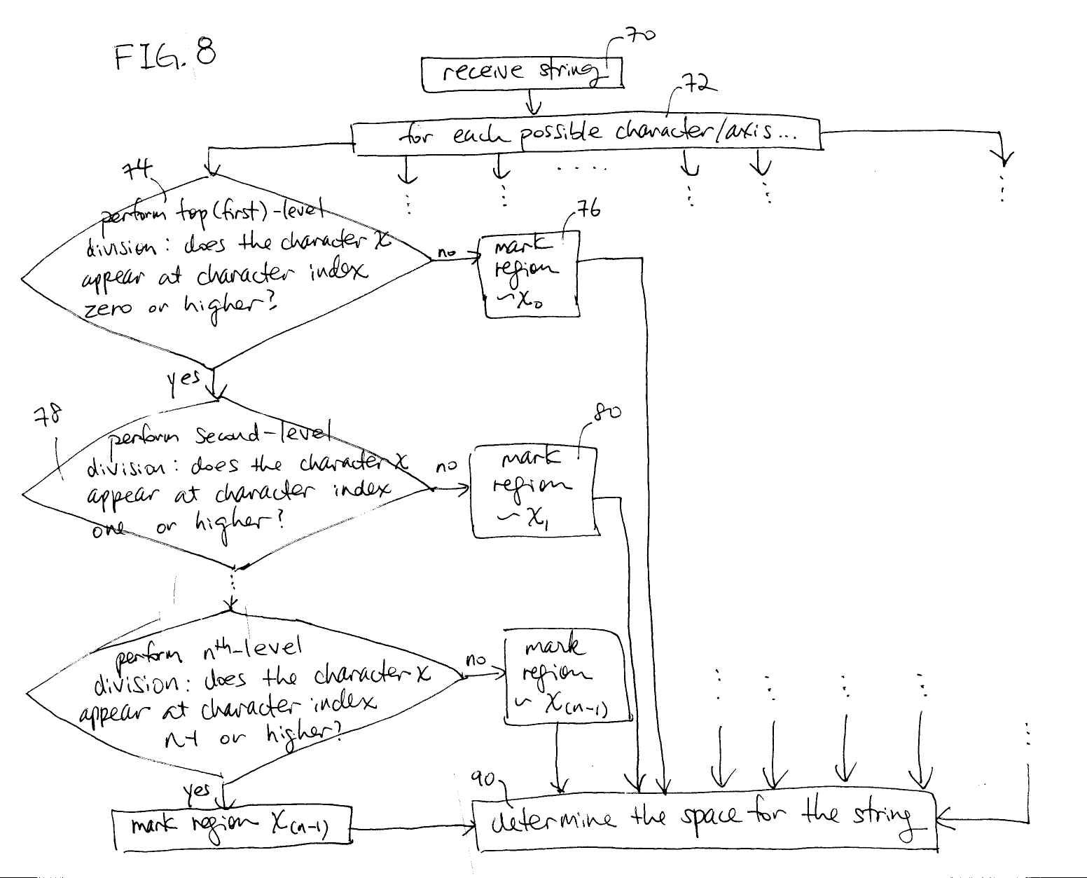

FIG. 6 illustrates a two-dimensional “space” composed of two axes, the A-axis and the B-axis, and how the multi-level division illustrated in FIGS. 1-4 applies to the multi-dimensional space. Although the figure depicts just the top-level division of A and B, the division generates four quadrants. Quadrant ˜A₀B₀ represents “strings that do not possess the letter A AND possess the letter B.” Quadrant A₀B₀ represents “strings that possess both the letter A AND the letter B,” Quadrant ˜A₀˜B₀ represents “strings that possess neither the letter A NOR the letter B,” and Quadrant A₀˜B₀ represents “strings that do not possess the letter B AND possess the letter A.” Although a two-axes example is provided for simplicity of illustration, it should be apparent that the method can be extended to a space with more dimensions.

FIG. 7 illustrates a second-level division performed in one of the quadrants of the two-axes space of FIG. 6. Let us now consider the integer representation of the string “ABABB.” The A-axis would have value 11111000 . . . , and the B-axis would have the value 111000 . . . A letter that is not present at all in a string (e.g., the letter C in this case) takes the value zero, and would be represented by an integer string 0000 . . . . One technique for representing k-d trees as integers is to interleave the bits, starting with the MSB. The values in the space will have 26*32 bits (the absence of a character in a string is treated as a value of zero on the given axis).

The conversion between an integer bit string and a Hilbert number in the desired number of dimensions can be performed using a well-known method. When re-ordered using the Hilbert number, strings that are similar tend to be ordered near each other. However, a more rigorous definition of similarity uses a Levenshtein distance. Organization by Hilbert re-ordering produces a sufficient reordering that by choosing a window of J entries, all indexed strings within a desired Levenshtein distance can often be captured. In practice, J can be sufficiently small (say 1000) that J represents a small fraction (e.g., less than 0.5%) of the total dictionary of indexed strings. A post filtering step is then applied to the window of J strings in which the Levenshtein distance to the input string is calculated for each of J strings in the window, and the J strings are then re-ordered by ascending Levenshtein distance to the input string. The application is then free to pick a window size J such that execution speed and recall performance can be tuned to the needs of the application.

FIG. 8 is a flowchart depicting the mapping process described in reference to FIGS. 1-7. As shown, the process begins when a string is received (step 70). Usually, there is a closed set of characters that can appear in a string—for example, in the case of English language, there are 26 letters and 9 numerals in the set of characters (plus, optionally, some symbols). Each possible character has its own dimension/axis (step 72). For each possible character, a top-level (first-level) division is performed to check if the particular character x appears at character index zero or higher (step 74), wherein the character x may be any character. Since character index of zero represents the rightmost character, this top-level division checks if the particular character x appears at all in the string. If the character x does not appear in the string, the region ˜x₀ is marked on the corresponding axis (step 76). If the character x does appear in the string, the second-level division is performed to see if the character x is present at character index one or higher (step 78). If the answer is no, the region ˜x₁ is marked on the axis (step 80). If the answer is yes, the third-level division is performed to see if the character x is present at character index two or higher, and so on until some region is marked on the axis. The results on all the axes are combined to identify a space that corresponds to the string received in step 70 (step 90). Although the steps for only one axis is shown in FIG. 8, this is done for simplicity of illustration and it will be understood that substantially similar steps are performed for each of the axes. At the conclusion of the process, each axis has a binary-number representation.

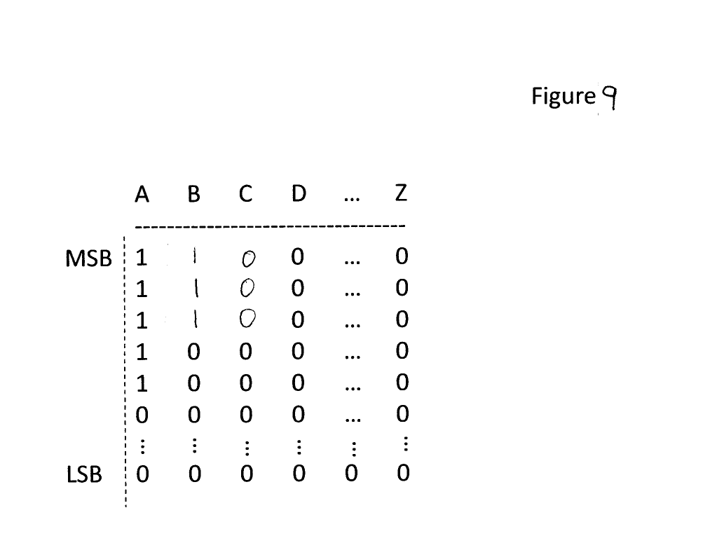

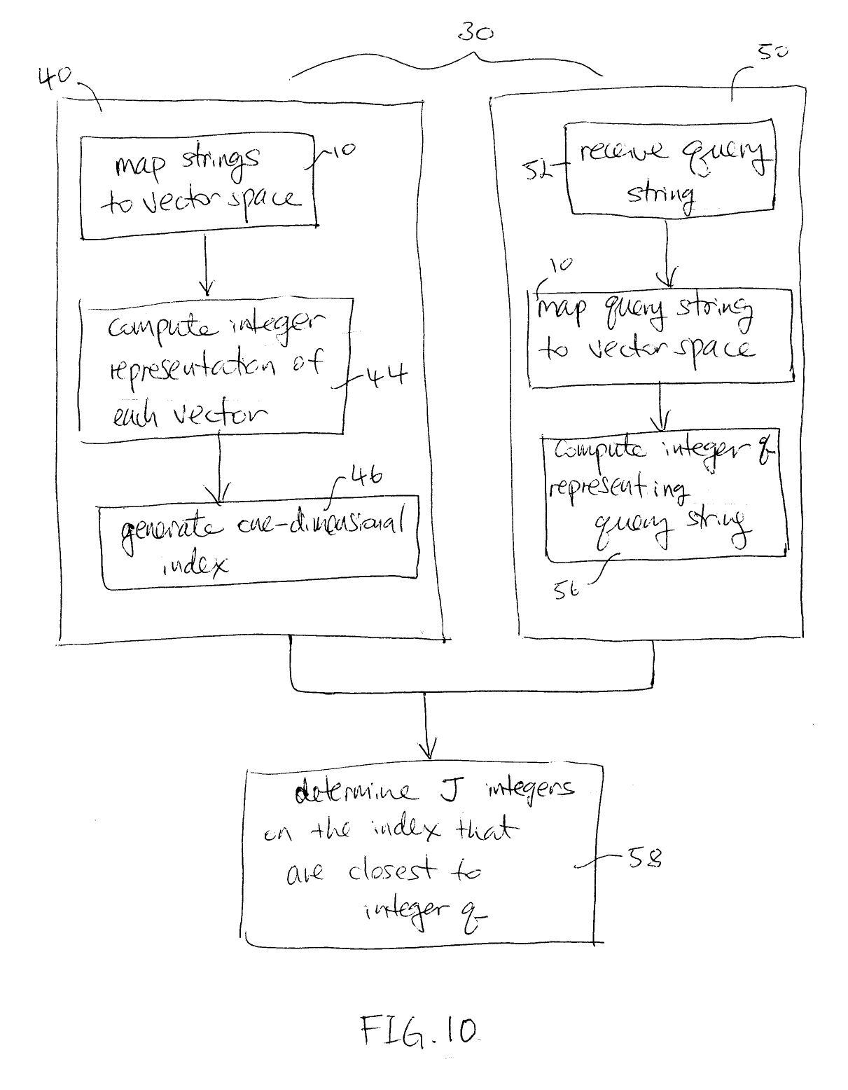

FIG. 9 illustrates the binary values for the string ABABB. When interleaved left to right, top to bottom according to an Interleaving technique, the single bit string for ABCD . . . ZABCD . . . ZABCD . . . becomes 1100 . . . 01100 . . . 01100 . . . 0100 . . . 0100 . . . 0000 . . . 0000 . . . etc.

The hierarchical encoding described for the two dimensional (A, B) example above takes the most significant bit of each D dimensions as the most significant D bits of the integer q. Therefore, where each dimension has two possible values (the 0 and the 1) correlating with two respective regions on an axis, the most significant bit of each of D dimensions determines the broadest region (herein also referred to as the “first region”) in which the final result will reside along a particular dimension. The second bit of each of D dimensions determines which region of the aforementioned first region the final result resides in, the third bit determines which region of the second region the final result resides in, and so on. The regions get narrower with each layer, such that the last bit has only one of two index locations to choose from on its respective dimension.

Therefore, in order to describe a string as a position in a k-dimensional hierarchical grid, a string is encoded in terms of hierarchical regions. Consider each character axis as being hierarchically divided as in a k-d tree. One can then consider the MSB for axis A to answer the question “does this string contain the character A?” A value of zero in the MSB means “no, there is no character A in this string.” A value of 1 in the MSB means “yes, there is a character A in this string.” One can then consider the second most significant bit to answer the question “does this string contain a second occurrence of A?” Notice that the value of the second most significant bit cannot be 1 if the MSB was zero. One can then consider the third most significant bit to answer the question “does this string contain a third occurrence of A?” A string of 1 bit is accreted, such that the length of the string is equal to the number of occurrences of A in the string.

In many languages, the first half of a word is often semantically more significant than the second half of a word. Therefore, two strings that are different in the first half are more likely to be different words than two strings that differ only in the second half. To weigh the difference properly, the following code may be implemented which differentiates between the first and second half of the strings in formulating the sequences of 1-bits described earlier for each axis:

```
char[ ] chars = s.toCharArray( );
int order = 0;
for (int i = 0; i < chars.length; i++) {
  int incr = 0;
  int cur = 0;
  int idx = chars[i] − ‘a’
  cur = components[idx];
  if (cur = = 0) {
    for (int j = 0; j < chars.length−i; j++) {
      int bias = (i <= chars.length/2 ? 0 : 1);
      components[idx] | = (1 << (NUM_BITS_RESULTION −
      1 − j − bias));
    }
  } else {
    for (int j = 0; j < chars.length−i; j++) {
      components[idx] | = (components[idx] >>> 1);
    }
  }
}//end for
```

For every character in the first half of the string, a number of bits proportional to the position of the character is set along the axis that corresponds to the character. The bits that get set first are the most significant bits (MSBs) as opposed to the least significant bits (LSBs) of the integer. If the same character appears more than once in the word, then for each additional time the character occurs, one additional bit is turned on along the corresponding axis.

A similar operation is applied for every character in the second half of the string, with one main modification. Instead of running the bits at the leftmost MSB, it starts at the second MSB, or the bit that is one bit less significant than the MSB. In the hierarchical division of the space described earlier, this corresponds to the range (0, MAX/2), a space that would otherwise never be occupied.

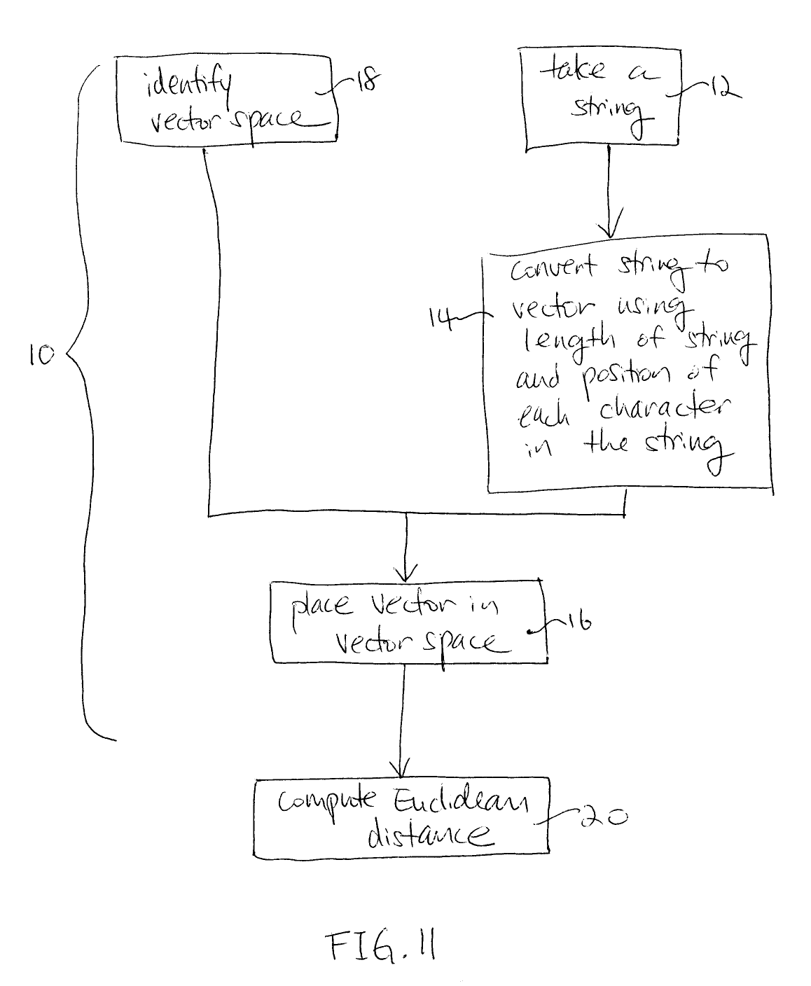

FIG. 10 is a flowchart depicting an index-matching process 30 in accordance with the inventive concept. Using the Mapping process described above in reference to FIGS. 2-8, a point that represents each string in a 26-dimensional space is determined. For efficient indexing and matching (i.e., distance comparison), the index-matching process 30 takes these points in the 26-dimensional space and converts them to integers using Interleaving. The index-matching process includes an indexing process 40 and a matching process 50.

For the indexing process 40, the words in the corpus are mapped to the space-filling curve as described above in the Mapping process. Different techniques, including but not limited to the Interleaving technique described above, may be used to convert the points in 26-dimensional space to a single integer in one-dimensional space (step 44). Step 44 converts the list of strings to a list of simple ordered integers and produces a one-dimensional index with an integer representing each word in the corpus (step 46). This one-dimensional index does not require a RAM-resident main structure for storage. For example, the index can be stored in well-known disc-based structure such as a B-tree.

Upon receiving a query string (step 52), the query string is mapped to the space-filling curve (Mapping process 10) and converted to a single integer q (step 56). To find a match for the query string, the index is scanned to find the J closest integers to the integer q (step 58). The one-dimensional index makes the matching process efficient as only a single-range scan is needed to find the match. With the one-dimensional index, the matching function, e.g. “find words like ‘doggy’,” is reduced to “determine the J closest integers to the integer q,” wherein the integer q represents the point on the Hilbert curve that corresponds to the query word. Only a single-range scan may be used to process the query (i.e. “find the largest J/2 integers less than q, and find the smallest J/2 integers greater than q”. In some implementations this requires 2 range queries.).

The integer conversion in steps 44, 56 may be done using the Hilbert space-filling curve, but this is not a limitation of the inventive concept. In one implementation, the Interleaving method described above may be used.

### Sum-Based Mapping Method

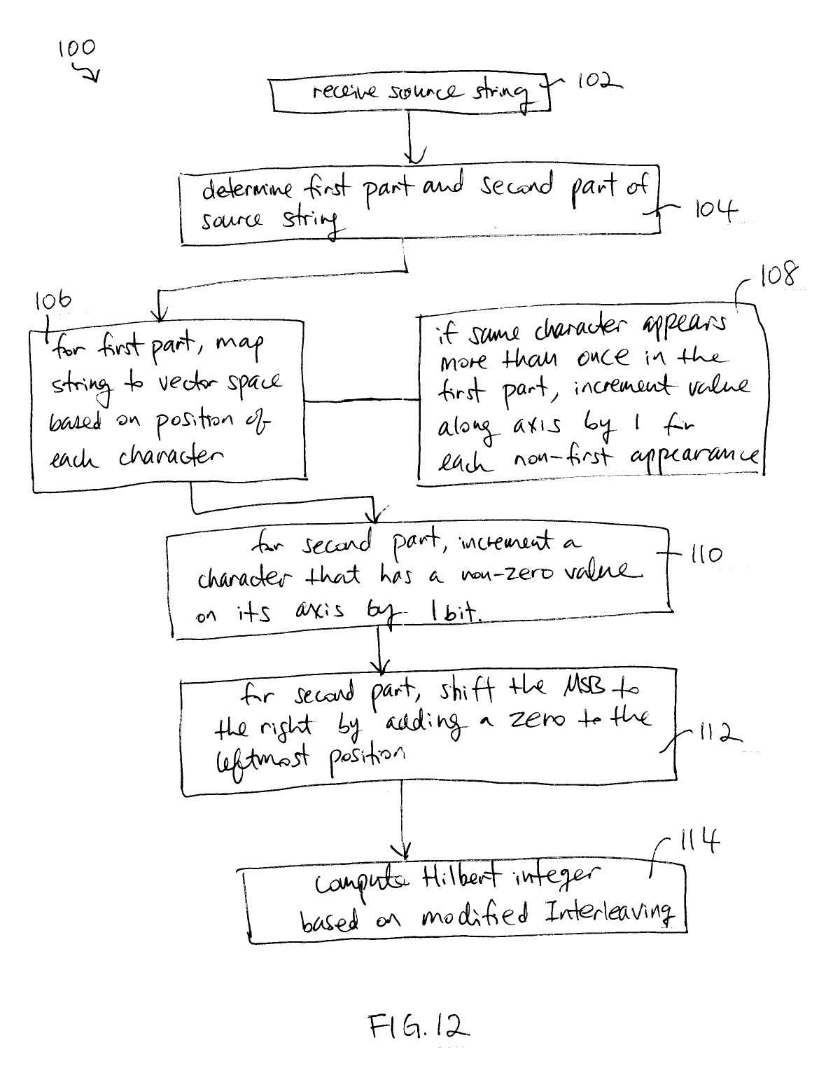

FIG. 11 is a flowchart depicting a simplified character-index-based mapping process 10 in accordance with one embodiment of the inventive concept. To generate this embodiment of “character index,” each character in the word is assigned a numeral/weight based on the length of the string and its position in the string. The first letter (i.e., the leftmost letter) is assigned the weight n, and the last letter (i.e., the rightmost letter) is assigned the weight m with the letters between them being assigned weights in descending order from n to m, wherein n and m are integers. For example, the character index, or the numerals assigned to the letters in the string “doggy” (where n=5 and m=1), would be as follows: d=5, o=4, g=3, g=2, y=1. In this embodiment, each vector represents a string. A vector space is identified wherein there is one axis for each potential member of the string (step 18). For example, in the case of English language, there may be a 26-axis vector space, one axis for each letter in the alphabet. Optionally, 10 more axes may be added for numerical digits 0-9, such that the vector space has a total of 36 axes. A string is presented (step 12), which may be a word from a corpus of documents. The string is then converted into a vector that represents it (step 14). In doing so, the a character index value n is assigned to the first letter in the string (e.g., n=5 for “doggy” where m=1) and a character index i is used to convert each character in the string to a non-zero component, all the way down to the character index m of the last letter. In one embodiment, n is based on the length of the string, and m is one. In code, this may be expressed as follows:

```
int[ ] components = new int[26]
for (int i = 0; i < chars.length; i++) {
  // assign weight based on distance from end of string
  components[chars[i] − ‘a’] += chars.length − i;
}
```

In one implementation of the method (a sum-based mapping method), the weights assigned to a letter are summed when the same letter appears multiple times in a string. Applying the sum-based mapping method to the string “doggy” would make the value along the g-axis g=3+2=5 where m=1. Hence, “doggy” is represented as a vector with non-zero components {5, 5, 4, 1} on four axes {d, g, o, y}, respectively. In this manner, the word “doggy” is represented in vector space as a point (step 16). After a plurality of strings is represented as points in the 26-dimensional space, distances between the points are computed (step 20). The assumption is that the strings that are closer together in the 26-dimensional space are more likely to be a match than the strings that are far apart. It should be appreciated that a distance metric other than Euclidean distance (such as Manhattan distance) could be applied as well.

The simplified character-index-based mapping method of FIG. 11 may be used for string matching, for example by predefining the maximum Euclidean distance that indicates a match. One of the benefits of the matching process based on the method of FIG. 11 is that the query string does not have to be spelled correctly for the matching to be effective. If the input is “dogy” instead of “doggy” or “tenis” instead of “tennis,” the misspelled words end up within the “J integer” range of the correctly-spelled word in the vector space.

### Average-Based Mapping Method

The sum-based mapping method described above may be used to map a string to a vector space. Using the sum-based mapping method, the letter “g” in the word “doggy” was assigned the value of 5 on the g-axis. An alternative method uses an average value instead of the sum when the same letter appears multiple times in a word.

In double-letter words, the letter that appears twice in a row tends to be the dominant axis value. As a result, misspelling a word by omitting one of the double letters may have the effect of causing the misspelled variation to be too far from the intended word in the mapping space. Using the average instead of the sum for the double letters mitigates the dominating effect of the double letters, thereby bringing the misspelled version closer to the correctly-spelled version in the vector space. This way, a user who inputs “dogy” instead of “doggy” will be presented with approximately the same match result as if the word had been spelled correctly.

It should be understood that the average-based mapping method and the sum-based mapping method may be combined selectively to achieve optimal result. For example, the average-based mapping method may be used only for the specific case of double-letter words where the same letter appears in adjacent positions. Hence, in one implementation, the average-based mapping method may be applied to the word “tennis” (where the two “n”s are immediately next to each other) but not to the word “nine.”

The vector space identified in step 18 may be mapped onto various lower dimensional spaces, for example, a one dimensional Hilbert space-filling curve. In the case of a 26-letter alphabet, 26 dimensions are mapped to a Hilbert curve which encodes each of 26 dimensions to a resolution of 32 divisions per dimension (i.e., 5-bit resolution per dimension). However, use of a Hilbert curve is not a limitation of the inventive concept and other alternative space-filling methods may be used.

The assignment of weights as a function of the length and position of the letter in a string is based on two assumptions. The first assumption is that important words generally contain more characters than unimportant words. This assumption is based on a distribution of word length vs. TF-IDF in a large corpus. The second assumption is that endings of English words (such as “ed,” “ing,” “ment,” ‘es”) are generally less important than beginnings By applying the highest weight to the letters in the beginning of the word and assigning weights in a descending fashion to subsequent characters, the methodology described above captures the notion that beginnings of words are more important than endings. The methodology may be modified and adapted for other languages based on the trends for the specific language.

For words in a corpus to be placed in a vector space, the vector is created as shown below:

| word | Vector (value in each axis) |
|---|---|
| doggy | d = 5, g = 5, o = 4, y = 1 |
| dog | d = 3, o = 2, g = 1 |
| cats | c = 4, a = 3, t = 2, s = 1 |
| . . . | . . . |

Once a query is received, Euclidean distance is used as a measure of word similarity to find words that may be a “match.” Upon receiving the word “doggy,” the distance between words “doggy” and “dog” is computed by comparing the distances along each axis individually, as follows:

Distance(doggy, dog)=sqrt[(5−3)²+(4−2)²+(5−1)²+(1−0)²]=5

In a similar manner, the distance between words “doggy” and “cat” is calculated as follows:

$$\begin{matrix}Distance ( doggy , cat ) = sqrt [ {( 5 - 0 )}^{2} + {( 4 - 0 )}^{2} + {( 5 - 0 )}^{2} + {( 1 - 0 )}^{2} + \\ {( 4 - 0 )}^{2} + {( 3 - 0 )}^{2} + {( 2 - 0 )}^{2} + {( 1 - 0 )}^{2} ] \\ = 9.95\end{matrix}$$

As the word “dog” is closer to the query word than the word “cat,” it would be a closer match to the word “doggy.”

### Interleaving

Interleaving is a process for combining the individual binary-number representation of each character in a string into an integer that represents the entire string. There are a number of Interleaving techniques that are known. For simplicity, examples will be given in the context of an alphabet that consists of two characters or letters, A and B. The words would then be mapped in a space with two axes, one for A and one for B. Let's examine the word “ABAB.” Where n=4 and m=1, the character index for each character would be as follows: the leftmost A=4, the left B=3, the right A=2, and the rightmost B=1. Using the Sum-based Mapping described below, the word “ABAB” would be converted to a vector as follows: A=4+2=6, B=3+1=4, and mapped on the two axes. The numbers 6 and 4, when represented in binary form, are 0110 and 0100, respectively. When the two binary numbers are written vertically, top to bottom, next to each other, a chart such as what is shown below is created with the MSB highest, and LSB lowest:

| A | B |
|---|---|
| 0 | 0 |
| 1 | 1 |
| 1 | 0 |
| 0 | 0 |

Rewriting the number going from left to right and row by row, one gets the binary number 00111000 which interleaves the two binary numbers. Converted to a decimal integer, the number is 112. Hence, this would be number that is used for the indexing and the matching.

As for the word “BBBB,” it would be converted to a vector as A=0 and B=4+3+2+1=10, and mapped on the two axes accordingly. The binary numbers would be 0000 and 1010.

| A | B |
|---|---|
| 0 | 1 |
| 0 | 0 |
| 0 | 1 |
| 0 | 0 |

Rewriting the number going from left to right and row by row, the pattern of numbers above results in the binary number 01000100, which is equivalent to the number 68. In the same manner, strings AAAA and BBAB can be converted to integers 136 and 132, generating a one-dimensional index as below:

| Word | Integer |
|---|---|
| AAAA | 136 |
| ABAB | 112 |
| BBAB | 132 |
| BBBB | 68 |

Based on the one-dimensional index, the distance between two words can be calculated. For example, the distance between ABAB and AAAA is 136−112=24. The distance between ABAB and BBBB is 112−68=44, and the distance between ABAB and BBAB is 132−112=20. The distances indicate how close of a match a word is to the query word. The shorter the distance between the two words, the closer of a match they are. The match result may be made as narrow or as broad as desired; for example, the match result may say “find J integers that are close to the integer q” wherein J=10. If J is set to 1000, many more match results will turn up, increasing the likelihood that the result that the user is looking for will be ensnared. However, as J increases, matches that are not as close to the integer q may also be included in the result. Post filtering of the results by ranking the K integers by their Levenshtein distance to the input string may be used to rank the J integers.

Each horizontal “slice” across the chart corresponds to slicing off the most significant bits of a binary representation of each axis value. The larger the number, the “higher” is the slice where the first “1” is encountered. When the ones and zeros are written vertically top to bottom, the highest “1”s are placed in the most significant bit of a binary number. In two dimensions (A, B), each pair of bits (i.e., each horizontal slice) corresponds to one of four quadrants of a quad tree (00, 01, 10, 11). When a long string of is and Os are written out, what is generated is a “quad tree” ordering of the bits which, although arguably not as good as a Hilbert curve at preserving locality, still has the property that for many points that fall inside the same quads, their decimal numbers will be close by each other. While the quad tree (or k-d tree when you have k dimensions instead of two dimensions) may not be as good at the Hilbert curve at preserving this property of spatial locality corresponding to integer-numbering locality, it may be an adequate alternative. However, converting the hierarchical interleaved integer to a Hilbert integer results in one-dimensional organization in which points near each other in k dimensions tend to be nearer each other in 1 dimensional space than they would be if we simply considered the interleaved integer as a one-dimensional space.

### Modified Interleaving Method

FIG. 12 depicts a flowchart illustrating a Modified Interleaving method 100. Upon receiving a source string (step 102), a first part and a second part of the string is determined (step 104). In one embodiment, where the source string is a single word, the first part and the second part may be determined by simply dividing the word into two parts, herein referred to as “halves.” For the first part, the mapping is performed as described above, for example in reference to FIG. 11 (step 16). If the same character appears more than once in the first part, the value of that character along its axis is incremented by 1 for each non-first appearance (step 108). For the second part of the source string, any character that already has a non-zero value (i.e., a character that also appeared in the first part of the string) will be incremented by 1 (step 110). For characters that appear for the first time in the second part of the string, the MSB is shifted to the right by adding a zero to the leftmost position (step 112). With these modifications, the interleaved integer is computed (step 114).

Suppose two parts of the word “doggy” are being weighted according to the Sum-based Mapping method described above. The binary axis value would be as follows:

| D | O | G | Y |
|---|---|---|---|
| 1 | 0 | 0 | 0 |
| 0 | 1 | 1 | 1 |
| 0 | 0 | 1 | 0 |
| 0 | 0 | 0 | 0 |

An interleaved integer 1000011100100000 is then formed. The conversion between the interleaved integer representation and the Hilbert integer can then be performed using one of several methods.

Although examples are provided herein to weigh two different parts of a string, it would be appreciated that the technique can be adjusted to weigh different parts of a string that is divided up into more than two regions.

### Multi-String Query

When the query is a multi-string query, such as a sentence, the individual word vectors are added to generate a vector for the string. For example, if the query is “how much is that doggy in the window,” the vector for the sentence would be computed as follows:

V(“how much is that doggy in the window”)=v(how)+v(much)+v(is)+v(that)+v(doggy)+v(in)+v(the)+v(window)

Some examples of sentences that represent a contiguous range of Hilbert number using the above method are provided below:

“*i was crazy about him the first party i saw him”
“on january 15, 1990, a historic new law was passed”
“*on january 320, 1990, a historic new law was passed”
“in january 1990, a historic new law was passed”
“i am ready and eager to go to the party”
“*almost three years, i saw ruth again”
“the nearest drug store is about ¾ of a mile away”
“they are the number 3 auto maker and a fortune 500 company”
“*who alice did really annoyed me”
“what alice did really annoyed me”
“her career lasted almost thirty years”
“*her career lasted almost thirty books”
“*we had an argument at whether it was a good movie”
“*almost three years for our first date, i saw ruth again”
“the data on file will be used for the project at hand, which is already under way”
“*he told them about the accident presumably”
“i saw her again a year and a half later”
“the former astronaut was alone and afraid”
“almost three years later, i saw ruth again”
“almost three years after our first date, i saw ruth again”
“almost three years after i first met her, i saw ruth again”
“the graduating of fred changes the situation”
“the 7-11 is half a mile up the road, but the supermarket is a long way away”
“*we argued adding new features to the program”
“included in our paper is a summary of the features of our program”
“*such flowers are found mainly particularly in europe”
“*we like to eat at restaurants, fortunately on weekends”
“your house and garden are very attractive”
“we like to eat at restaurants, usually on weekends”
“he is apparently an expert on dogs”
“*he knows apparently an expert on dogs”
“the apparently angry man walked out of the room”
The vectors for sentences would be processed in the same manner as the vectors for words.

### Using Multiple Set of Axes

Sometimes, there may be undesirable crosstalk between words. A “crosstalk” happens when two words that happen to have similar arrangement of letters get grouped together during the matching process 50 even though the two words actually are not close. For example, suppose there is a first vector including the words “xxx” and “xingyu” (the latter being a non-English word) and a second vector including the words “zzz” and “you.” In a 26-dimensional space, there may be crosstalk between the vectors because the word “xingyu” and the word “you,” both of which have the arrangement “y . . . u,” cause the vectors to have similar values on the y-axis and the u-axis.

This type of crosstalk may be avoided by dividing the vector space into multiple sets of 26-axis space. For example, two sets of 26 axes may be used, effectively creating 52 axes or dimensions a₁-z₁ and a₂-z₂. With this setup, each character has a primary dimension and a secondary dimension.

In an example embodiment where the string “aaabc aaa” is being indexed, the string is first subdivided, or tokenized (e.g., into “aaabc” and “aaa”). The tokens (the subdivided strings) are then lexicographically sorted (e.g., “aaa” is before ‘aaabc”) and a zero-based index is assigned (e.g., aaa=0, aaabc=1). The vectors for the tokens are added to generate an overall vector for the entire string, as described above. However, for each character in the token, either the primary axis or the secondary axis is selected by taking the token's zero-based index. In the case of “aaa,” since it has a token index of 0, its vector would use the primary axis. On the other hand, in the case of “aaabc” with token index 1, the secondary axis would be used.

One generalization of this multi-axes technique entails selecting a set of axes by taking the token index and modulo-dividing it by the number of axis sets. For example, the string “asaa aaabc aaabcd aaazz” may be indexed with corresponding token indices {0, 1, 2, 3}, respectively and, by modulo division, the respective sets of axes would be {0, 1, 01}.

Optionally, one could build two spellcheck indexes, one for the regular string (e.g., “doggy”) and one for the reverse string (e.g., “yggod”). This dual-index approach improves accuracy when the head of the string contains a severe typographical error but the tail of the string remains intact. Generally, a spellchecking function may be implemented by scanning a set number (x) of Hilbert integers before and after the computed Hilbert integer (e.g., x=1000).

Any appropriate number axis sets may be used.

While use of multiple sets of axes may be helpful for spell checking, it may not be as helpful for accurate matching. Some empirical studies show that the greater the number of axis-sets that are used, the more the long strings (sentences) tend to align around having the same number of words, diluting the closeness of the match. By using a single set of axes, a more accurate match may be obtained.

On the other hand, when matching index keys (i.e., in a keyword search with a small number of discrete tokens), the proximity of words to their misspelled variations improves with the number of sets of axes.

Hence, the method may entail selectively combining a single-set axis mapping and multi-set axis mapping to yield the optimal result depending on the task that the user is accomplishing. For example, if the user is if the user's goal is to take 1000 sentences and process them against a corpus of documents, a single set of axes may be used. On the other hand, if the goal is to support keyword search with powerful spellchecking, a larger number of axes sets may be desirable.

Various embodiments of the present disclosure may be implemented in or involve one or more computer systems. The computer system is not intended to suggest any limitation as to scope of use or functionality of described embodiments. The computer system includes at least one processing unit and memory. The processing unit executes computer-executable instructions and may be a real or a virtual processor. The computer system may include a multi-processing system which includes multiple processing units for executing computer-executable instructions to increase processing power. The memory may be volatile memory (e.g., registers, cache, random access memory (RAM)), non-volatile memory (e.g., read only memory (ROM), electrically erasable programmable read only memory (EEPROM), flash memory, etc.), or combination thereof. In an embodiment of the present disclosure, the memory may store software for implementing various embodiments of the present disclosure.

Further, the computer system may include components such as storage, one or more input computing devices, one or more output computing devices, and one or more communication connections. The storage may be removable or non-removable, and includes magnetic disks, magnetic tapes or cassettes, compact disc-read only memories (CD-ROMs), compact disc rewritables (CD-RWs), digital video discs (DVDs), or any other medium which may be used to store information and which may be accessed within the computer system. In various embodiments of the present disclosure, the storage may store instructions for the software implementing various embodiments of the present disclosure. The input computing device(s) may be a touch input computing device such as a keyboard, mouse, pen, trackball, touch screen, or game controller, a voice input computing device, a scanning computing device, a digital camera, or another computing device that provides input to the computer system. The output computing device(s) may be a display, printer, speaker, or another computing device that provides output from the computer system. The communication connection(s) enable communication over a communication medium to another computer system. The communication medium conveys information such as computer-executable instructions, audio or video information, or other data in a modulated data signal. A modulated data signal is a signal that has one or more of its characteristics set or changed in such a manner as to encode information in the signal. By way of example, and not limitation, communication media includes wired or wireless techniques implemented with an electrical, optical, RF, infrared, acoustic, or other carrier. In addition, an interconnection mechanism such as a bus, controller, or network may interconnect the various components of the computer system. In various embodiments of the present disclosure, operating system software may provide an operating environment for software's executing in the computer system, and may coordinate activities of the components of the computer system.

Various embodiments of the inventive concept disclosed herein may be described in the general context of computer-readable media. Computer-readable media are any available media that may be accessed within a computer system. By way of example, and not limitation, within the computer system, computer-readable media include memory, storage, communication media, and combinations thereof.

Having described and illustrated the principles of the inventive concept with reference to described embodiments, it will be recognized that the described embodiments may be modified in arrangement and detail without departing from such principles. It should be understood that the programs, processes, or methods described herein are not related or limited to any particular type of computing environment, unless indicated otherwise. Various types of general purpose or specialized computing environments may be used with or perform operations in accordance with the teachings described herein. Elements of the described embodiments shown in software may be implemented in hardware and vice versa.

While the exemplary embodiments of the inventive concept are described and illustrated herein, it will be appreciated that they are merely illustrative.

What is claimed is:

1. A computer-implemented method of comparing strings, comprising:
mapping a first string and a second string in a multi-dimensional space where each axis represents a character that appears in at least one of the first and second strings;
using the mapped positions of the first and second strings in the multi-dimensional space to generate first and second one-dimensional representations of the first and second strings, respectively; and
determining a degree of similarity between the first string and the second string based on a difference between the first and second one-dimensional representations.

2. The method of claim 1, wherein mapping the first string in the multi-dimensional space comprises determining a position for each of the characters in the first string on a corresponding axis based on the character's frequency of appearance and position of appearance in the first string.

3. The method of claim 1, wherein the multi-dimensional space includes a first axis, the mapping comprises:
dividing the first axis into a first region and a second region;
assigning the string the first region on the first axis in case a first character is absent from the string; and
assigning the string the second region in case the string includes the first character.

4. The method of claim 3, wherein the mapping further comprises:
subdividing the second region into a third region and a fourth region; and
assigning the string either a third region or a fourth region based on a position of the first character in the string.

5. The method of claim 1, wherein generating the one-dimensional representation of the first string comprises:
generating a binary representation of each character in the first string; and
interleaving binary representations of a plurality of characters to obtain a combined binary number.

6. The method of claim 5, wherein generating the one-dimensional representation further comprises converting the combined binary number to an integer q.

7. The method of claim 6 further comprising identifying a preset number of closest-matching strings to the first string by determining J closest integers to the integer q.

8. A computer-implemented method of mapping a string in a multi-dimensional space that includes a first axis, the method comprising:
dividing the first axis into a first region and a second region, wherein the first axis represents a first character;
assigning the string to the first region if the first character is absent from the string; and
assigning the string to the second region if the string includes the first character.

9. The method of claim 8 further comprising:
subdividing the second region into a third region and a fourth region;
assigning the string to the third region in case the first character is in a specific position in the string or comes after the specific position; and
assigning the string to the fourth region in case the first character is before a specific position in the string.

10. The method of claim 8, wherein the dividing of the first axis into a first region and a second region comprises dividing the first axis into two halves of about equal size.

11. The method of claim 8 further comprising mapping the string on a second axis, the method comprising:
dividing the second axis into two regions; and
assigning the string to one of the two regions based on presence of a second character in the string.

12. The method of claim 11 further comprising:
subdividing at least one of the two regions on the second axis into two subdivisions; and
assigning the string to one of the subdivisions based on the position of the second character in the string.

13. The method of claim 8, wherein there are D axes including the first axis and each of the D axes represents one character such that the number of potential characters is equal to D.

14. The method of claim 8 further comprising converting the string to a binary number, wherein a most significant bit of each of the D axes corresponds to a most significant D bit of the binary number.

15. The method of claim 14 further comprising interleaving binary numbers to obtain a one-dimensional representation, wherein the interleaving comprises:
horizontally laying out the potential characters;
vertically writing the binary number for each character in a corresponding column; and
reading the resulting matrix of numbers left to right and top to bottom.

16. A non-transitory computer-readable medium storing instructions that, when executed, cause a computer to perform a method for positioning a string on a one-dimensional space-filling curve, the method comprising:
mapping the string in a multi-dimensional space that includes a first axis by:
dividing the first axis into a first region and a second region; and
assigning the string to the first region or the second region depending on presence of a first character in the string, wherein the first character is represented by the first axis; and
converting the mapped position into a one-dimensional representation.

17. The computer-readable medium of claim 16, wherein the mapping further comprises:
subdividing the first region into a third region and a fourth region; and
assigning the string to the third region or the fourth region depending on the position of the first character in the string.

18. The computer-readable medium of claim 16, wherein the multi-dimensional space further comprises a second axis that represents a second character, and wherein the mapping further comprises:
dividing the second axis into a third region and a fourth region; and
assigning the string to the third region or the fourth region depending on presence of the second character in the string.
